(19) United States
(12) Patent Application Publication
(10) Pub. No.: US 2021/0239274 A1
(43) Pub. Date: Aug. 5, 2021

(54) INSPECTION PORT SYSTEM FOR THERMALLY INSULATED PIPES, VESSELS, AND THE LIKE

(71) Applicant: Jhonny R. Ramirez Dala, Miramar, FL (US)

(72) Inventor: Jhonny R. Ramirez Dala, Miramar, FL (US)

(21) Appl. No.: 17/250,017

(22) PCT Filed: Jun. 26, 2018
(86) PCT No.: PCT/US2018/039543

§ 371 Date: Nov. 3, 2020

(51) Int. Cl. F17C 13/02; F16L 55/115; F16L 55/105; F17C 13/06; F16L 59/14

(52) U.S. Cl. CPC F17C 13/02; F16L 55/115; F16L 59/14; F17C 13/06; F16L 55/105

(57) ABSTRACT

An inspection port system for a thermally insulated pipe, vessel, and the like is described. The inspection port system includes a base and a lid. The base defines a base plate with a central opening and a projecting sidewall projecting from a rim of the central opening. The projecting sidewall defines a tapered cylindrical inside surface. The lid defines a tapered cylindrical outside surface and includes a handle that can lock the lid to the base. The lid is dimensioned such that the tapered cylindrical outside surface can seal directly against the tapered cylindrical inside surface with the lid inserted into the base and the lid locked to the base by the handle. In use, the base may be attached to the jacket of the thermally insulated equipment and may provide a means of readily accessing the equipment for periodic inspection.

### FIELD OF THE INVENTION

The present invention relates generally to thermally insulated pipes, vessels, and the like, and, more particularly, to inspection port systems for use with such equipment.

### BACKGROUND OF THE INVENTION

The petroleum, chemical, and petrochemical industries extensively utilize pipes and vessels such as towers, drums, tanks, and heat exchangers in their processing facilities. This equipment may be run at temperatures ranging from below zero degrees Celsius to temperatures as high as, for example, 510 degrees Celsius. As a result, this industrial equipment is often fitted with thermal insulation to help to minimize temperature fluctuations and to reduce the costs of maintaining non-ambient temperatures. Insulation is also used to limit condensation and mold growth, and to provide freeze protection. Finally, insulation may provide protection to personnel, fire safety, and noise reduction.

Most thermal insulation tends be weak in terms of mechanical strength and displays high porosity, making it susceptible to accumulating moisture. Consequently, thermal insulating layers are often covered with covers or jackets comprising sheets of aluminum, stainless steel, or galvanized steel. Nonetheless, the thermal insulating layers and their jackets create a physical barrier to the underlying equipment when they need inspection. Periodic inspection is needed to ensure equipment is not corroding or is not being compromised in some other manner. Ultrasound techniques, for example, may be utilized to periodically determine the wall thickness of a pipe to establish whether it needs replacement or repair.

Inventors have attempted to develop inspection ports that allow access to the underlying thermally insulated equipment without requiring that the insulating system first be dismantled. Such attempts are described in, for example, U.S. Pat. Nos. 4,091,842; 5,351,718; 5,518,033; and 7,946,444, which are not admitted as prior art by their citation herein. Nevertheless, each of these systems tends to suffer from one or more disadvantages: being overly complicated and difficult to utilize; being expensive; utilizing materials that are not capable of handling the wide temperature ranges required; degrading in sunlight; not sealing well with underlying equipment that is curved such as cylindrical pipes; being sensitive to minor imperfections created during installation; and not allowing the use on corrugated jackets.

There is, as a result, a need for improved inspection port systems for use with thermally insulated piping, vessels, and the like that address the aforementioned shortcomings.

### SUMMARY OF THE INVENTION

Embodiments of the present invention provide improved inspection port systems for use with thermally insulated pipes, vessels, and other equipment.

Aspects of the invention are directed to a kit comprising a base and a lid. The base defines a base plate with a central opening and a projecting sidewall projecting from a rim of the central opening. The projecting sidewall defines a tapered cylindrical inside surface. The lid defines a tapered cylindrical outside surface and comprises a handle operative to lock the lid to the base. The lid is dimensioned such that the tapered cylindrical outside surface is operative to seal directly against the tapered cylindrical inside surface with the lid inserted into the base and the lid locked to the base by the handle.

Additional aspects of the invention are directed to an apparatus comprising a thermally insulating layer, a jacket, a base, and a lid. The thermally insulating layer defines a first opening, and the jacket contacts the thermally insulating layer and defines a second opening in communication with the first opening. The base is attached to the jacket and is at least partially disposed within the first opening and the second opening. The base defines a base plate with a central opening and a projecting sidewall projecting from a rim of the central opening. The projecting sidewall defines a tapered cylindrical inside surface. The lid defines a tapered cylindrical outside surface and comprises a handle operative to lock the lid to the base. The lid is dimensioned such that the tapered cylindrical outside surface is operative to seal directly against the tapered cylindrical inside surface with the lid inserted into the base and the lid locked to the base by the handle.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of an inspection port system in accordance with an illustrative embodiment of the invention in combination with a thermally insulated pipe;

FIG. 2 shows an exploded perspective view of the FIG. 1 inspection port system in combination with the thermally insulated pipe;

FIG. 3 shows an exploded perspective view of elements of the FIG. 1 inspection port system;

FIG. 4 shows an exploded sectional view of the FIG. 1 inspection port system in combination with the thermally insulated pipe;

FIG. 5 shows a sectional view of elements of the FIG. 1 inspection port system with the lid separate from the base;

FIG. 6 shows a sectional view of elements of the FIG. 1 inspection port system with the lid partially inserted into the base;

FIG. 7 shows a sectional view of the base of the FIG. 1 inspection port system in combination with a corrugated jacket; and

FIG. 8 shows a perspective view of elements of an alternative inspection port system in accordance with another illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

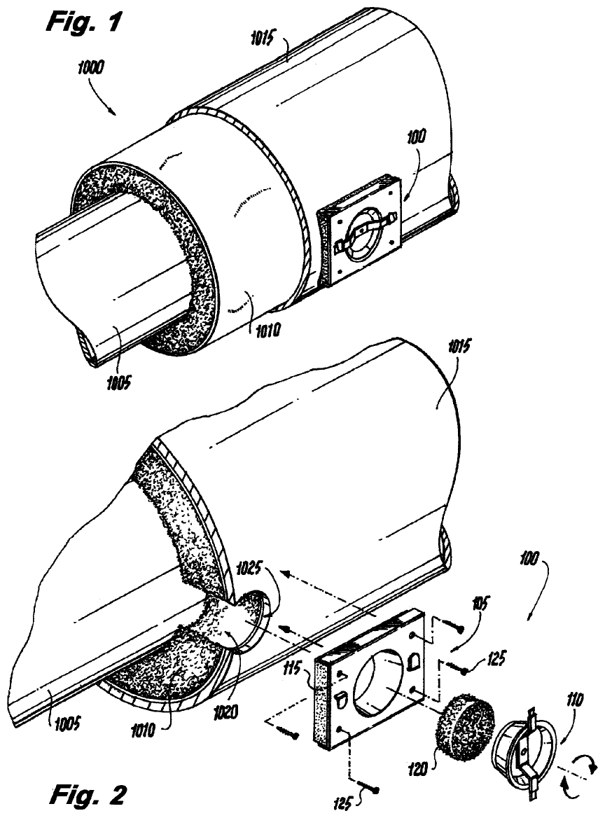

Aspects of the invention include an inspection port system for use with thermally insulated pipes, vessels, and other equipment that might be found in, for example, a petroleum, chemical, or petrochemical processing facility. FIG. 1 shows a perspective view of an inspection port system 100 in accordance with an illustrative embodiment of the invention in combination with a thermally insulated pipe 1000. FIG. 2 shows an exploded perspective view of the same illustrative inspection port system 100 and the thermally insulated pipe 1000. The thermal insulation of pipelines, subsea equipment, vessels, and tanks will be familiar to one having ordinary skill in the relevant arts. It is also described in a number of readily available publication including, for example, A. Bandori, Thermal Insulation Handbook for the Oil, Gas, and Petrochemical Industries, 1^{st} Edition, Gulf Professional Publishing, 2014, which is hereby incorporated by reference herein.

In the thermally insulated pipe 1000, a pipe 1005 is surrounded by a thermally insulating layer 1010, which, in turn, is surrounded by a jacket 1015. The jacket 1015 directly contacts the thermally insulating layer 1010. To allow periodic inspection of the pipe 1005, the thermally insulating layer 1010 defines a first opening 1020, and the jacket 1015 defines a second opening 1025 in communication with the first opening 1020. The inspection port system 100 comprises a base 105, a lid 110, a sealing gasket 115, and a thermally insulating plug 120. The base 105 is attached to the jacket 1015 via a set of screws 125. The lid 110 may be removably inserted into and locked to the base 105, allowing the lid 110 and the base 105 to form a hermetic seal in the first and second openings 1020, 1025. The thermally insulating plug 120 sits within the second opening 1025 in the thermally insulating layer 1010. For inspection, the lid 110 and the thermally insulating plug 120 can be easily removed through and from the base 105 to gain direct access to the pipe 1005 through the first and second openings 1020, 1025.

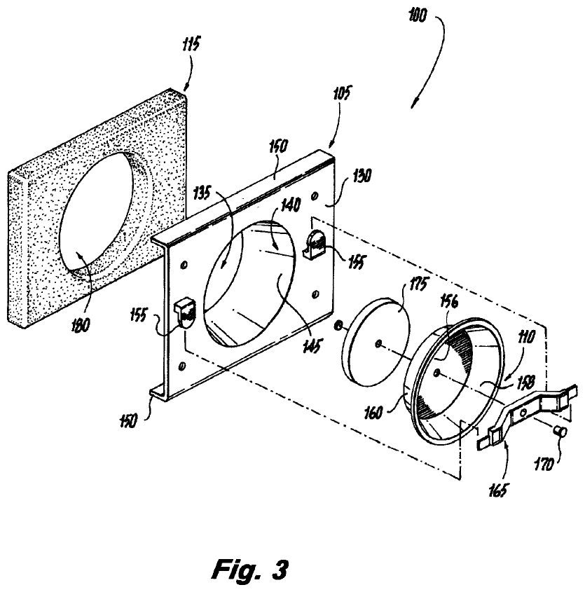

Additional details of the inspection port system 100 are shown in exploded perspective view in FIG. 3. The base 105 defines a base plate 130 with a central opening 135 passing therethrough. A projecting sidewall 140 projects from a rim of the central opening 135 and defines a tapered cylindrical inside surface 145. Two edge projections 150 project from opposite edges of the base plate 130 in spaced relation to one another and at normal angles to the base plate 130. Two catches 155 also project from the base plate 130. The catches 155 are positioned on opposite sides of the central opening 135.

The lid 110 describes a bowl-shaped element with a bottom 156 and a raised sidewall 158 with a tapered cylindrical outside surface 160. The lid 110 also comprises a handle 165 that is rotatably attached to the remainder of the lid 110 by a fastener 170 (e.g., rivet). With the lid 110 fully inserted into the base 105, the handle 165 may be rotated so that extensions at opposite ends of the handle 165 engage the catches 155. In this manner, the lid 110 may be locked to the base 105 with the tapered cylindrical outside surface 160 of the lid 110 sealed directly against the tapered cylindrical inside surface 145 of the base 105 (where “directly” means without any intermediary elements). A thermally insulating plate 175 of thermally insulating material is attached to the bottom 156 of the lid 110 using the same fastener 170 as the handle 165 for attachment.

The sealing gasket 115 is designed to be positioned between the base plate 130 and the jacket 1015 and is preferably formed of a readily deformable material (e.g., an elastomer). The sealing gasket 115 defines a central passageway 180 that allows the projecting sidewall 140 to pass through it. The sealing gasket 115 has a thickness slightly larger than the lengths by which the edge projections 150 project from the base plate 130. As a result, the sealing gasket 115 projects somewhat past the edge projections 150 when not deformed.

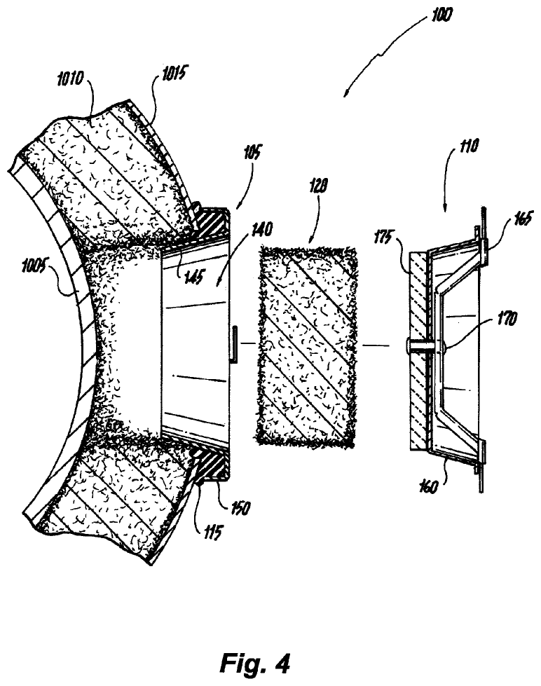

FIG. 4 shows an exploded sectional view of the inspection port system 100 in combination with the thermally insulated pipe 1000 from FIG. 1. When attached to the thermally insulated pipe 1000, a part of the projecting sidewall 140 occupies the first and second openings 1020, 1025 in the thermally insulating layer 1010 and the jacket 1015, respectively. The projecting sidewall 140 thereby forms a walled conduit through at least part of the first and second openings 1020, 1025. The sealing gasket 115 occupies a space between the jacket 1015 and the base plate 130 and elastically conforms to the curvature of the jacket 1015 (and, more generally, the curvature of the entire thermally insulated pipe 1000). The edge projections 150 run along the longitudinal axis of the jacket 1015 (i.e., transverse to the curvature of the jacket 1015), and, accordingly, do not interfere with the ability of the base 105 to adapt to jackets having differing shapes (e.g., different diameters). The thermally insulating plug 120 is inserted into the first opening 1020 in the thermally insulating layer 1010 and, so placed, occupies a space between the pipe 1005 and the remainder of the inspection port system 100.

The deformation of the sealing gasket 115 helps to effectively seal the inspection port system 100 to the thermally insulated pipe 1000 so that thermal energy and matter may not enter into or escape from the interfacial regions between these systems. The sealing gasket 115 tends to deform to fill in any gaps between the jacket 1015 and the edge projections 150, and any gaps between the jacket 1015 and the projecting sidewall 140 (both visible in FIG. 4).

The lid 110 may be inserted into the base 105 and, once so placed, the handle 165 may be rotated to engage the catches 155 and thereby lock the lid 110 in place. Engaging the lid 110 with the base 105 forms a hermetic seal between the tapered cylindrical outside surface 160 of the lid 110 and the tapered cylindrical inside surface 145 of the base 105. In one or more embodiments of the invention, the tapered cylindrical outside surface 160 may have a shape approximately equal to the shape of the tapered cylindrical inside surface 145. Conversely, in other embodiments, the tapered cylindrical outside surface 160 and the tapered cylindrical inside surfaces 145 may intentionally be formed with somewhat different shapes to enhance the direct seal between the surfaces 145, 160. These differences in shape help to create what is sometimes called an “interference fit,” a “press fit,” or a “friction fit” between the base 105 and the lid 110.

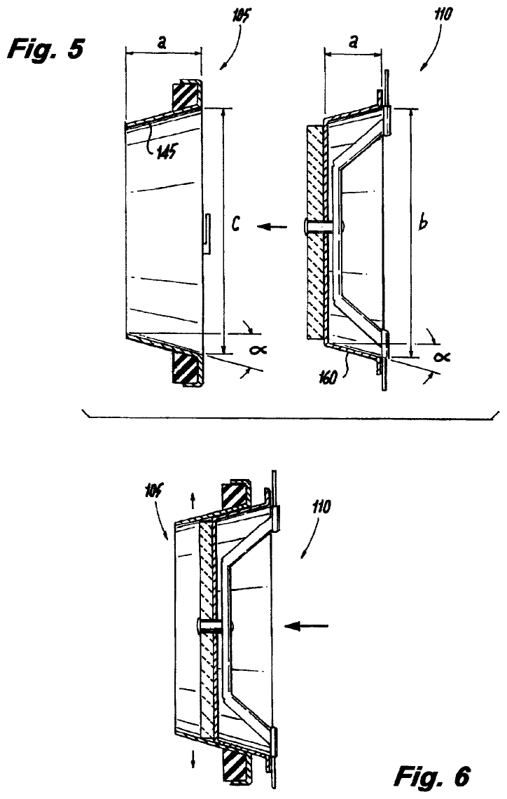

FIG. 5 shows a sectional view of elements of the inspection port system 100 with the lid 110 separate from the base 105, while FIG. 6 shows a sectional view of the inspection port system 100 with the lid 110 partially inserted into the base 105. In this particular embodiment, the tapered cylindrical outside surface 160 and the tapered cylindrical inside surface 145 are not identical in shape. More particularly, while both surfaces 145, 160 have identical taper angles (labeled as α on FIG. 5) and depths (labeled as a in FIG. 5), the maximum diameter of the tapered cylindrical outside surface 160 of the lid 110 (labeled as b on FIG. 5) is slightly larger than the maximum diameter of the tapered cylindrical inside surface 145 of the base 105 (labeled as c on FIG. 5). The inner component (i.e., the tapered cylindrical outside surface 160 of the lid 110) is therefore larger than the outer component (i.e., the tapered cylindrical inside surface 145 of the base 105). Accordingly, there is some deformation to one or both of the base 105 and the lid 110 from their respective relaxed shapes when the lid 110 is fully inserted into the base 105 and the lid 110 is locked to the base 105 by the handle 165. For purposes of this description and the appended claims, an object takes on its “relaxed shape” when the object is not acted on mechanically by any other object.

FIG. 6 helps demonstrate such deformation. In the particular illustrative embodiment shown in the figure, further insertion of the larger lid 110 into the smaller base 105 causes outward deformation of the projecting sidewall 140 of the base 105, as suggested by the outward pointing arrows in the figure. In other embodiments, the lid 110 could instead deform, or both the base 105 and the lid 110 could deform. Independent of what element actually deforms, such an interference fit increases the pressure between the tapered cylindrical outside surface 160 of the lid 110 and the tapered cylindrical inside surface 145 of the base 105 above that which would exist without such an interference fit, and also helps to maintain that higher pressure over long periods of time. The increased pressure, in turn, helps to establish and maintain a tighter seal between the elements, lessening the chances of both thermal leakage and the leakage of liquids or gases past the seal.

Installation of the illustrative inspection port system 100 on the thermally insulated pipe 1000 may be accomplished by initially forming the first and second holes 1020, 1025 in the thermally insulating layer 1010 and the jacket 1015, respectively, and then attaching the inspection port system 100 to the jacket 1015 to achieve the configuration shown in FIGS. 1 and 4. The set of screws 125 that penetrate the base plate 130 and the jacket 1015 aid with the fixation. Once so attached, the lid 110 and the thermally insulating plug 120 may be removed to directly access the pipe 1005 for inspection. After the inspection, the thermally insulating plug 120 may be replaced and the lid 110 inserted into the base 105 and locked in place to restore the hermetic seal provided by the inspection port system 100.

When in place and the lid 110 locked to the base 105, the novel inspection port system 100 provides thermal insulation to the pipe 1005 nearly equivalent to that provided by the thermally insulating layer 1010 and the jacket 1015 in an intact region of the thermally insulated pipe 1000. The insulating plug 120 and the thermally insulating plate 175 help to stop thermal transfer through the inspection port system 100, but, ultimately, their use is considered optional. In alternative embodiments falling within the scope of the invention, the thermally insulating plug 120 and the thermally insulating plate 175 are not used, and the inspection port system 100 instead depends on an air gap between the pipe 1005 and the inspection port system 100 to help provide the needed thermal barrier.

Elements of the inspection port system 100 may be formed utilizing readily available materials and conventional manufacturing techniques. These materials and manufacturing techniques will already be familiar to one having ordinary skill in the relevant arts after understanding the description provided herein. The base 105 and the lid 110 of the inspection port system 100 may, for example, be formed of a metal or any polymer or composite material able to withstand the thermal, chemical, and mechanical forces at play in the industrial environment of interest. Suitable metals may include, as just two examples, aluminum and steel. The sealing gasket 115 may be formed of relatively deformable, thermally insulating material such as, for example, silicone rubber. The thermally insulating plug 120 may comprise, for example, fiberglass, and the thermally insulating plate 175 may comprise, for example, a ceramic or an aerogel. Nevertheless, it is again emphasized that the specific materials recited herein are only by way of example.

The inspection port system 100, and, more generally, embodiments falling within the scope of the invention, provide several advantages. These advantages include, but are not limited to:
The ability to provide a highly effective hermetic sealing means for an inspection window that is cut into the insulation and jacket of a pipe, vessel, or other piece of equipment;
The ability to be opened and closed numerous times without degradation in function;
The ability to accommodate underlying equipment, vessels, and pipes with various shapes and those having both smooth and corrugated jackets;
The ability to be easily installed with a minimum of holes formed in a jacket;
The ability to be easily removed;
The ability to be reused;
The ability of the lid to lock to the base so that the lid can face downward without departing from the base;
The ability to withstand high and low temperatures;
The ability to withstand extended exposure to sunlight; and
The ability to withstand exposure to chemical compounds present in industrial environments.

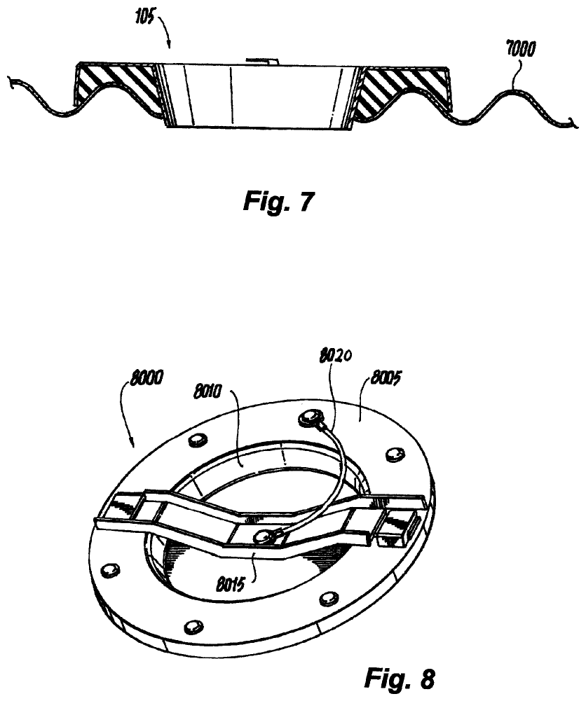

The ability of the inspection port system 100 to accommodate thermally insulated pipes, vessels, and other equipment with differing shapes is further illustrated by FIG. 7, which shows a sectional view of the base 105 of the inspection port system 100 mounted to a corrugated jacket 7000. In this configuration, the sealing gasket 115 again conforms to the underlying jacket 7000, readily accommodating the ridges in the jacket 7000 while still providing an effective seal to the inspection port system 100. In a like manner, the inspection port system 100 is able to accommodate a myriad of other shapes.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

In one or more alternative embodiments falling within the scope of the invention, for example, a putty may replace a sealing gasket. Moreover, in other embodiments, the thermally insulating plug 120 and/or the thermally insulating plate 175 may not be included, as set forth above. In even other embodiments, an inspection port system may not be a parallelepiped (e.g., rectangular) when viewed top down in the manner of the inspection port system 100, but may instead be a different shape. An alternative inspection port system may, for instance, be round. FIG. 8 shows a perspective view of such an alternative inspection port system 8000 with a base 8005 and a lid 8010 with a handle 8015. A retaining strap 8020 spans between the lid 8010 and the base 8005, and helps to avoid misplacing the lid 8010 during inspections by allowing the lid 8010 to dangle from the base 8005 while not in use. A similar retaining strap may be added to the inspection port system 100 and other embodiments falling within the invention if so desired.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in AIA 35 U.S.C. § 112(f). In particular, the use of “steps of” in the claims herein is not intended to invoke the provisions of AIA 35 U.S.C. § 112(f).

What is claimed is:

1. A kit comprising:
a base defining a base plate with a central opening and a projecting sidewall projecting from a rim of the central opening, the projecting sidewall defining a tapered cylindrical inside surface; and
a lid defining a tapered cylindrical outside surface and comprising a handle operative to lock the lid to the base;
wherein the lid is dimensioned such that the tapered cylindrical outside surface is operative to seal directly against the tapered cylindrical inside surface with the lid inserted into the base and the lid locked to the base by the handle.

2. The kit of claim 1, wherein the base further defines an edge projection projecting from an edge of the base plate.

3. The kit of claim 2, wherein the edge projection projects at a substantially normal angle from the edge.

4. The kit of claim 2, wherein the base further defines a second edge projection projecting from a second edge of the base plate in spaced relation to the edge projection.

5. The kit of claim 4, wherein the second edge projection projects at a substantially normal angle from the second edge.

6. The kit of claim 1, wherein the lid is dimensioned such that the tapered cylindrical outside surface is operative to seal against the tapered cylindrical inside surface to create a hermetic seal therewith.

7. The kit of claim 1, wherein the handle is rotatably attached to a remainder of the lid.

8. The kit of claim 7, wherein the base defines a catch projecting from the base plate.

9. The kit of claim 8, wherein the handle is operative to be rotated such that a portion of the handle engages the catch when the lid is locked to the base with the tapered cylindrical outside surface sealed directly against the tapered cylindrical inside surface.

10. The kit of claim 1, wherein at least one of the base and the lid is deformed from its respective relaxed shape when the lid is locked to the base with the tapered cylindrical outside surface sealed directly against the tapered cylindrical inside surface.

11. The kit of claim 1, further comprising a sealing gasket defining a central passageway, wherein the sealing gasket is positionable against the base with a portion of the projecting sidewall disposed in the central passageway.

12. The kit of claim 11, wherein the sealing gasket comprises an elastomer.

13. The kit of claim 1, wherein the lid further comprises a circular plate of thermally insulating material.

14. The kit of claim 1, wherein the base plate is rectangular or round.

15. An apparatus comprising:
a thermally insulating layer defining a first opening;
a jacket contacting the thermally insulating layer and defining a second opening in communication with the first opening;
a base attached to the jacket and at least partially disposed within the first opening and the second opening, the base defining a base plate with a central opening and a projecting sidewall projecting from a rim of the central opening, the projecting sidewall defining a tapered cylindrical inside surface; and
a lid defining a tapered cylindrical outside surface and comprising a handle operative to lock the lid to the base;
wherein the lid is dimensioned such that the tapered cylindrical outside surface is operative to seal directly against the tapered cylindrical inside surface with the lid inserted into the base and the lid locked to the base by the handle.

16. The apparatus of claim 15 further comprising a sealing gasket positioned between the base and the jacket.

17. The apparatus of claim 15, further comprising a pipe or vessel underlying the thermally insulating layer.

18. The apparatus of claim 15, further comprising a fastener passing through the base and the jacket to fixate the base to the jacket.

19. The apparatus of claim 15, wherein the jacket defines a curved outside surface and the base is attached to the curved outside surface.

20. The apparatus of claim 15, wherein the jacket defines a corrugated outside surface and the base is attached to the corrugated outside surface.
